(19) United States
(12) Patent Application Publication
(10) Pub. No.: US 2025/0235984 A1
(43) Pub. Date: Jul. 24, 2025

(54) Multi-Component Masking System

(71) Applicant: Chromalloy Gas Turbine LLC, Palm Beach Gardens, FL (US)

(72) Inventors: Zachary Oras, Riverview, FL (US); Zachary Hopkins, San Diego, CA (US); Logan Mitchell, Tampa, FL (US)

(21) Appl. No.: 18/415,750

(22) Filed: Jan. 18, 2024

(51) Int. Cl. B24C 1/04; B33Y 80/00

(52) U.S. Cl. CPC B24C 1/04; B33Y 80/00

(57) ABSTRACT

A masking system for selectively masking a component is disclosed. In some aspects, the masking system has a first shell including a first seating area configured to seat at least a first part of a first side of the component. The masking system has a second shell including a second seating area configured to seat at least a second part of a second side of the component. The masking system includes an intermediate member securable to the first shell and the second shell such that when the first part and the second part are respectively seated within the first seating area and the second seating area, the intermediate member contacts a terminal portion of the component.

### CROSS REFERENCE TO RELATED APPLICATIONS

None.

### FIELD OF THE DISCLOSURE

The disclosure relates generally to the field of masking systems. More specifically, the disclosure relates to a masking system for masking a part for a media blasting process.

### SUMMARY

The following presents a summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

In an aspect of the disclosure, a masking system for selectively masking a component is disclosed. The masking system has a first shell including a first seating area configured to seat at least a first part of a first side of the component. The masking system has a second shell including a second seating area configured to seat at least a second part of a second side of the component. The masking system includes an intermediate member securable to the first shell and the second shell such that when the first part and the second part are respectively seated within the first seating area and the second seating area, the intermediate member contacts a terminal portion of the component.

In an aspect, according to any one of the preceding aspects, the first shell has a first opening, the second shell has a second opening, and the intermediate member has a third opening; the first opening, the second opening, and the third opening can be aligned; and the alignment of the first opening, the second opening, and the third opening is associated with movement of the intermediate member towards the terminal portion of the component.

In an aspect, according to any one of the preceding aspects, the masking system includes a fastening system for securing the first shell, the second shell, and the intermediate member.

In an aspect, according to any one of the preceding aspects, the intermediate member has a first portion having a first angled end and a second angled end, a second portion that extends from the first angled end, and a third portion that extends from the second angled end.

In an aspect, according to any one of the preceding aspects, the second portion has a first projection and the third portion has a second projection that faces the first projection.

In an aspect, according to any one of the preceding aspects, at least one of the first projection and the second projection is frusto-triangular.

In an aspect, according to any one of the preceding aspects, the intermediate member further comprises a plugging member for plugging an aperture in the component.

In an aspect, according to any one of the preceding aspects, the masking system is configured to be disposed in a shot peen apparatus.

In an aspect, according to any one of the preceding aspects, at least a portion of each of the first shell and the second shell is compressible to allow the first shell and the second shell to be disposed in a can of the shot peen apparatus.

In an aspect, according to any one of the preceding aspects, the component is a component of a gas turbine.

In an aspect, according to any one of the preceding aspects, the component is a blade.

In an aspect, according to any one of the preceding aspects, the first part includes at least a portion of a shank of the blade.

In an aspect, according to any one of the preceding aspects, the intermediate member is hollow.

In an aspect, according to any one of the preceding aspects, the intermediate member is filled with a strengthening material.

In an aspect of the disclosure, a masking system for selectively masking a component is provided. The masking system includes a first shell having a first portion and a second portion that extends from the first portion. The first portion has associated therewith a first seating area. The masking system includes a second shell having a first part and a second part that extends from the first part. The first part has associated therewith a second seating area. The masking system includes an intermediate member securable to the first portion and the first part. The intermediate member is configured to contact a terminal portion of the component when the component is retained within the first seating area and the second seating area.

In an aspect, according to any one of the preceding aspects, the intermediate member is generally U-shaped.

In an aspect, according to any one of the preceding aspects, the intermediate member is filled with a strengthening material.

In an aspect, according to any one of the preceding aspects, each of the first shell and the second shell are additively manufactured.

In an aspect, a masking system for masking a component to undergo a media blasting process includes a first shell, a second shell securable to the first shell, and an intermediate member securable to the first shell and the second shell. When the component is retained by the first shell and the second shell, a portion of the component extends from the first shell and the second shell and contacts the intermediate member.

In an aspect, according to any one of the preceding aspects, each of the first shell and the second shell have a compressible portion.

In an aspect, according to any one of the preceding aspects, the first shell has a first opening, the second shell has a second opening, and the intermediate member has a third opening; the first opening, the second opening, and the third opening can be aligned; and the alignment of the first opening, the second opening, and the third opening is associated with movement of the intermediate member towards the portion of the component.

In an aspect, according to any one of the preceding aspects, the masking system includes a fastening system for fastening the first shell to the second shell and the intermediate member.

### BRIEF DESCRIPTION OF THE DRAWINGS

Illustrative embodiments of the present disclosure are described in detail below with reference to the attached drawing figures and wherein:

FIG. 1 is a perspective view of a turbine blade, according to some aspects of the disclosure.

FIG. 2 is a perspective view of a turbine vane, according to some aspects of the disclosure.

FIGS. 3A and 3B are perspective views of another turbine blade, according to some aspects of the disclosure.

FIG. 4A is a perspective view of a masking system, according to some aspects of the disclosure.

FIG. 4B is an exploded view of the masking system of FIG. 4A.

FIG. 5A is a front view of a first shell of the masking system of FIG. 4A.

FIG. 5B is a rear view of the first shell of the masking system of FIG. 4A.

FIG. 5C is a perspective view of the first shell of the masking system of FIG. 4A.

FIG. 6A is a front view of a second shell of the masking system of FIG. 4A.

FIG. 6B is a rear view of the second shell of the masking system of FIG. 4A.

FIG. 6C is perspective view of the second shell of the masking system of FIG. 4A.

FIG. 7A is a perspective view showing the first shell and the second shell proximate each other prior to securement.

FIG. 7B is a perspective view showing the first shell and the second shell in contact with each other for securement.

FIG. 7C is a back view showing the first shell and the second shell in contact with each other for securement.

FIG. 8A is a front view of an intermediate member of the masking system of FIG. 4A.

FIG. 8B is a rear view of the intermediate member of the masking system of FIG. 4A.

FIG. 9A is a front view of the masking system showing a misalignment between openings associated with the intermediate member, the first shell, and the second shell.

FIG. 9B is a rear view of the masking system showing a misalignment between openings associated with the intermediate member, the first shell, and the second shell.

FIG. 9C is a rear view of the masking system showing the openings associated with the intermediate member, the first shell, and the second shell after they are aligned with each other.

FIG. 10 is a perspective view showing fastening systems of the masking system of FIG. 4A.

FIG. 11 is a perspective view showing the fastening systems fastening the first shell, second shell, and intermediate member of the masking system of FIG. 4A.

FIG. 12A is a rear view of the second shell with a blade associated therewith.

FIG. 12B is a rear view of the first shell with a blade associated therewith.

FIG. 12C is a perspective view of the masking system of FIG. 4A with the blade retained therein.

FIG. 13A is a schematic illustration of a shot peen apparatus.

FIG. 13B is a schematic illustration of the shot peen apparatus of FIG. 13A being used to shot peen blades situated within masking systems of FIG. 4A.

FIGS. 14A-14C are perspective views of the intermediate member, according to some aspects of the disclosure.

FIG. 15 is a perspective view of a masking system, according to some aspects of the disclosure.

FIG. 16A is a schematic view showing the masking system of FIG. 15 in an initial state.

FIG. 16B is a schematic view showing the masking system of FIG. 15 in a compressed state.

FIG. 17 is a flowchart illustrating a methods of making and using a making systems, according to some aspects of the disclosure.

### DETAILED DESCRIPTION

A gas turbine engine typically includes a multi-stage compressor coupled to a multi-stage turbine via an axial shaft. Air enters the gas turbine engine through the compressor where its temperature and pressure are increased as it passes through subsequent stages of the compressor. The compressed air is then directed to one or more combustors where it is mixed with a fuel source to create a combustible mixture. This mixture is ignited in the combustors to create a flow of hot combustion gases. These gases are directed into the turbine causing the turbine to rotate, thereby driving the compressor. The output of the gas turbine engine can be mechanical thrust via exhaust from the turbine or shaft power from the rotation of an axial shaft, where the axial shaft can drive a generator to produce electricity.

The compressor and turbine each include a plurality of rotating blades and stationary vanes having an airfoil extending into the flow of compressed air or flow of hot combustion gases. Each blade or vane has a particular set of design criteria which must be met to provide the necessary work to the flow passing through the compressor and the turbine. However, due to the severe nature of the operating environment, especially in the turbine, it is often necessary to cool these blades and vanes. The blades and vanes often utilize complex internal cooling passageways in order to maximize the efficiency of cooling fluid passing therethrough.

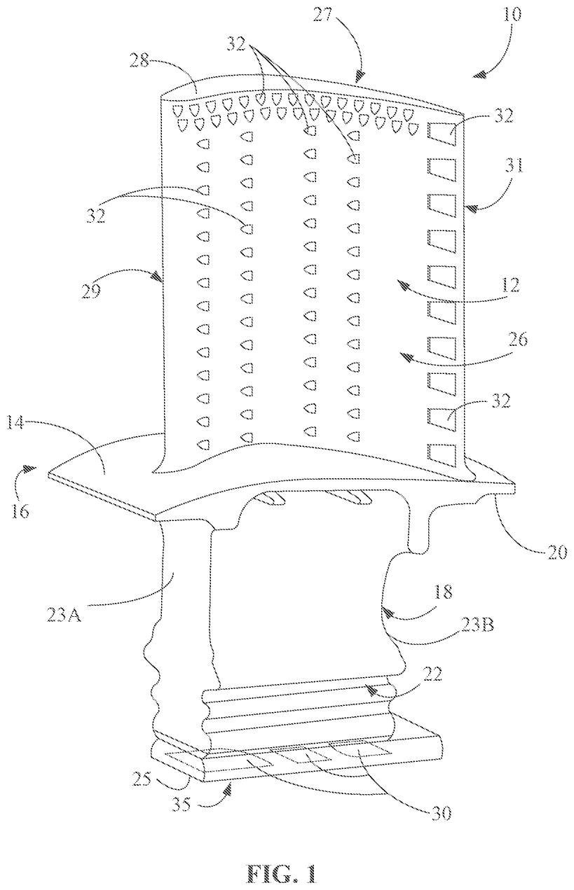

FIG. 1 shows a gas turbine component, such as a gas turbine blade 10. The turbine blade 10 generally includes an airfoil 12 extending from a top or gas path side surface 14 of a platform 16 and a root fixing portion or “dovetail” 18 depending from an undersurface 20 of the platform 16. The dovetail 18 may include one or more serrations or tangs 22 that extend laterally from one side 23A of the dovetail 18 to an opposing side 23B of the dovetail 18. The dovetail 18 may terminate at a terminal or bottom wall 25 that may span between the dovetail sides 23A and 23B. The dovetail 18, including the tangs 22 and the bottom wall 25 thereof, may be adapted for interlocking engagement in a corresponding slot defined in the periphery of a hub of a turbine rotor. The bottom wall 25 may be part of a metering plate 35 that is brazed or otherwise secured to the dovetail 18.

The airfoil 12 may have a pressure side 26, a suction side 27 opposite the pressure side 26, a tip 28, a leading edge 29, and a trailing edge 31. The tip 28 may include or may be configured to interact with a tip shroud, not shown for ease of illustration. The tip shroud may be provided at the tip 28 of each blade 10, or may be a stationary ring including one or more circumferentially extending sections each connected to the gas turbine casing. The tip shroud(s) may be configured to seal the gap between the tip 28 of the blade 10 and stationary components (e.g., stators) of the turbine, and thereby, may reduce leakage flow between the rotating and stationary components. The airfoil 12, e.g., the pressure side 26 thereof, may come into contact with combustion gases that are at an extremely high temperature. The airfoil 12 or portions thereof may therefore be coated with heat-resistant, wear-resistant, and/or other coatings. During operation, the tip 28 may rub against the tip shroud, and the tip 28 may therefore additionally or alternately be coated with wear-resistant coatings. In like fashion, one or more other portions of the blade 10 may be coated with different materials depending on the environment in which these portions are located and the stresses encountered thereby.

The bottom wall 25 of the dovetail 18 may include one or more air inlet apertures 30. Further, one or more portions of the blade 10 may include cooling holes 32 for cooling the blade 10 during operation. The cooling holes 32 may be provided on one or more surfaces of the airfoil 12, such as the pressure side 26, the suction side 27, the tip 28, the leading edge 29, the trailing edge 31, or a combination thereof. The cooling holes 32 may be circular cooling holes, diffused (e.g., angled) cooling holes, cooling slots, or take on one or more other regular or irregular shapes. Cooling gas may pass through internal cooling channels (not illustrated for ease of description) in the blade 10 and emerge from the cooling holes 32 to create a thin film over the outer surface of the airfoil 12, thus reducing direct contact of the hot gases and the surfaces of the blade 10. For example, the illustrated blade 10 has air inlet apertures 30 in the bottom wall 25 of the dovetail 18 and cooling holes 32 on the pressure side 26 of the airfoil 12. The blade 10, including the airfoil 12 thereof, may include hollow interior passages for the passage of cooling air, for example, but not limited to, from air inlet apertures 30 to cooling holes 32. Thus, cooling air may be bled from the compressor and channeled into the air inlet apertures 30. This cooling air may exit out the cooling holes 32 to cool one or more portions of the blade 10 during operation. As embodied by the disclosure, different blades may have differing cooling schemes and that the inlet apertures 30 and cooling holes 32 in FIG. 1 are merely exemplary and not intended to be independently limiting.

A gas turbine blade, such as the blade 10, may be manufactured using investment casting, also referred to in the art as lost-wax processing. The investment casting process may involve making a precise negative die of the blade shape that is filled with wax to form the blade shape. If the blade, such as the blade 10, is hollow and has interior cooling passages, a ceramic core in the shape of the cooling passages may be inserted into the middle. The wax blade may be coated with a heat-resistant material to make a shell, and then that shell may be filled with the blade alloy.

Once cast, the blade 10 may undergo one or more finishing processes to prepare the blade 10 for operation. The finishing processes may ensure that the blade 10 has the required aerodynamic profile, as such may impact engine efficiency and fuel consumption. The finishing processes may also make the blade 10 more resistant to fatigue, and thereby increase the lifespan of the blade 10. Some finishing processes may reduce the maintenance requirements associated with the blade 10.

The finishing processes may include one or more of machining the blade 10, coating one or more portions of the blade 10 with heat-resistant, wear-resistant, and/or other suitable coatings, or one or more other processes. In some examples, the finishing processes may include a media blasting process. For example, one or more portions of blade 10 may be media blasted with abrasive media (such as sand or grit) to prepare these portions to receive coating. Alternately or in addition, one or more portions of blade 10 may be blasted with abrasive media to fortify these portions. For example, one or more surfaces of dovetail 18 may be shot peened for fortification.

Shot peening one or more portions of dovetail 18 may be one of the last steps carried out in the production of blades 10. In a shot peening process, metal shots or pellets may be discharged in a stream of pressurized air over the surface of a metal workpiece to plastically deform the surface layer of the workpiece and introduce residual compressive stress therein. The residual compressive stress may reduce the stresses experienced in blade 10 during operation, such as in the rotating environment of the gas turbine engine. Since the shot peening process is carried out at the end of the manufacturing cycle for a typical blade 10, care must be used in the process to avoid damaging blade 10 or incompletely shot peening the intended surfaces thereof. Uniform shot peening of the entire dovetail 18 of blade 10, for example, may ensure increased strength of blade 10 during operation and a correspondingly long service life.

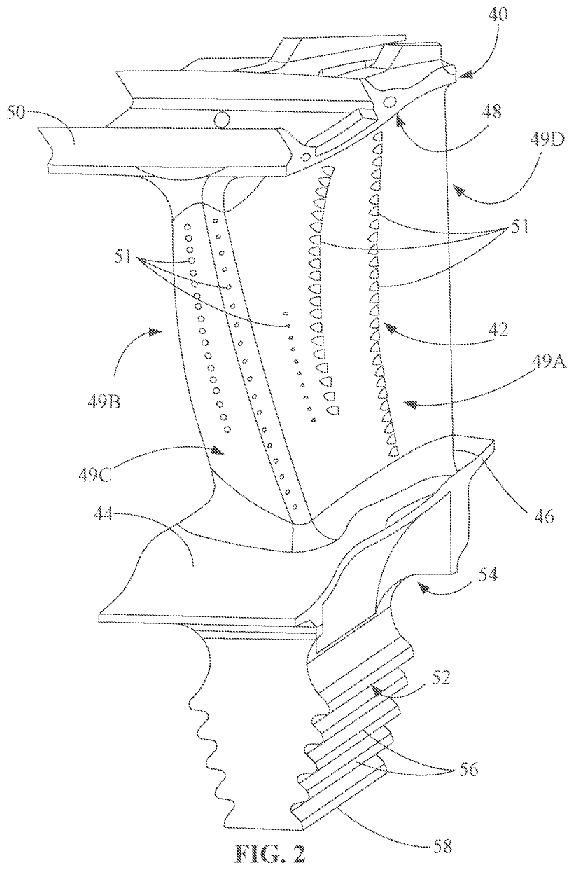

FIG. 2 show another gas turbine component, i.e., a gas turbine vane 40. The turbine vane 40 generally includes an airfoil 42 extending between a top or gas path inner surface 44 of an inner shroud section 46 and a bottom or gas path outer surface 48 of an outer shroud section 50. Airfoil 42 may include a pressure side 49A, a suction side 49B (not clearly shown in FIG. 2) that opposes pressure side 49A, a leading edge 49C, and a trailing edge 49D (not clearly shown for ease of illustration) that generally opposes leading edge 49C. One or more portions of the vane 40 may include cooling holes 51 for cooling vane 40 during operation. The cooling holes 51 may be provided on one or more surfaces of the airfoil 42, such as the pressure side 49A, the suction side 49B, the leading edge 49C, the trailing edge 49D, or a combination thereof. In some examples, cooling holes 51 may be provided on other portions of vane 40, such as on the outer shroud section 50. The cooling holes 51 may be circular cooling holes, diffused (e.g., angled) cooling holes, cooling slots, or take on one or more other regular or irregular shapes.

Turbine vane 40 further includes a dovetail 52 depending from an undersurface 54 of the inner shroud section 46. The dovetail 52 may include one or more serrations or tangs 56 that extend laterally from one side of the dovetail 52 to an opposing side of the dovetail 52. The dovetail 52 may terminate at a terminal or bottom wall 58 that may span between the dovetail sides. The dovetail 52, including the tangs 56 and the bottom wall 58 thereof, may be adapted for interlocking engagement in a corresponding slot defined in a housing of the gas turbine engine.

The dovetail 52, like the dovetail 18 of blade 10, may be media blasted, e.g., may be shot peened to ensure increased strength of vane 40 during operation and a correspondingly long service life. When dovetail 52 is being media blasted in this manner, one or more other portions of vane 40 may be masked to protect these portions from being impacted by the media.

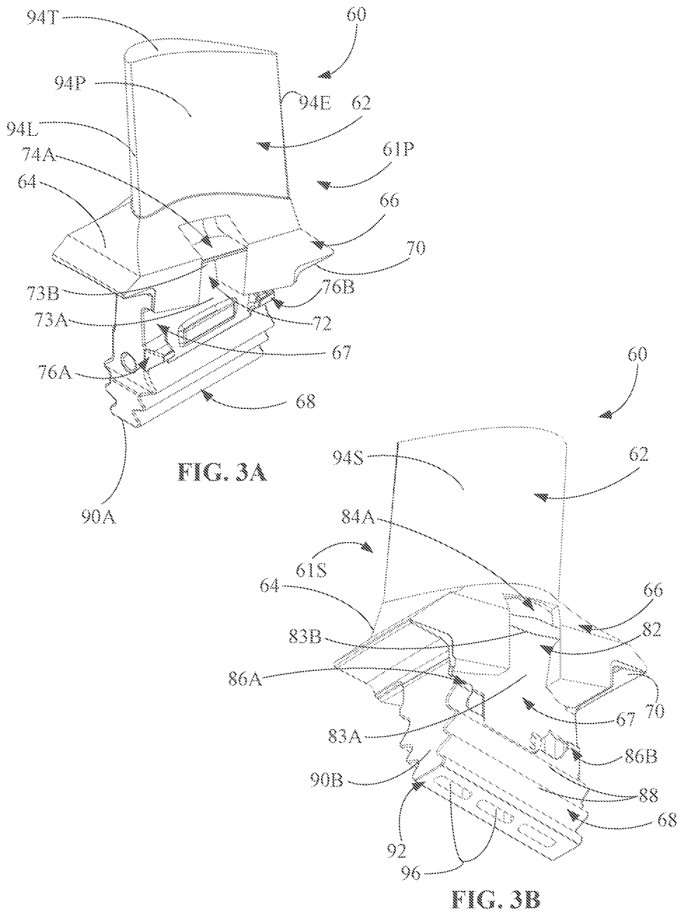

FIGS. 3A and 3B show another gas turbine blade 60. FIG. 3A generally shows a pressure side 61P of blade 60 and FIG. 3B generally shows a suction side 61S of blade 60. The turbine blade 60 includes an airfoil 62 extending radially outwardly from a top or gas path surface 64 of a platform 66, a shank 67 that extends radially inwardly from platform 66 to a root fixing portion or dovetail 68, and dovetail 68 which extends radially inwardly from shank 67.

The platform 66 may have an undersurface 70 that opposes the gas path surface 64. The shank 67, on pressure side 61P of blade 60, may include a first recessed portion 72 (FIG. 3A) defined by an undercut on undersurface 70 (best visible in FIG. 3B) of platform 66. In some examples, first recessed portion 72 may have an open end 73A and a closed end 73B. Open end 73A may be radially inward of the closed end 73B (i.e., open end 73A may be proximate to dovetail 68 relative to closed end 73B). Closed end 73B may be closed by a shelf 74A that laterally spans the undercut on platform 66 on the pressure side 61P. The shank 67 may further include tabs or protrusions 76A and 76B (FIG. 3A) on the pressure side 61P of blade 60.

Similarly shank 67, on suction side 61S of blade 60, may include a second recessed portion 82 (FIG. 3B) defined by an undercut on undersurface 70 of platform 66. In some examples, second recessed portion 82 may have an open end 83A and a closed end 83B. Open end 83A may be radially inward of the closed end 83B (i.e., open end 83A may be proximate to dovetail 68 relative to closed end 83B). Closed end 83B may be closed by a shelf 84A that laterally spans the undercut of platform 66 on the suction side 61S. The shank 67 may further include tabs or protrusions 86A and 86B on the suction side 61S of blade 60.

The dovetail 68 may include one or more serrations or tangs 88 that extend laterally from one side 90A (FIG. 3A) of the dovetail 68 to an opposing side 90B (FIG. 3B) of dovetail 68. The dovetail 68 may terminate at a terminal or bottom wall 92 that may span between the dovetail sides 90A and 90B. The dovetail 68, including the tangs 88 and the bottom wall 92 thereof, may be adapted for interlocking engagement in a corresponding slot defined in the periphery of a hub of a turbine rotor. The bottom wall 92 may be part of a metering plate (not illustrated for ease of understanding) that is brazed or otherwise secured to the dovetail 68.

The airfoil 62 may have a pressure side 94P, a suction side 94S opposite the pressure side 94P, a tip 94T, a leading edge 94L, and a trailing edge 94E. The tip 94T may include or may be configured to interact with a tip shroud. The tip shroud may be provided at the tip 94T of each blade 60, or may be a stationary ring including one or more circumferentially extending sections each connected to the gas turbine casing. The tip shroud(s) may be configured to seal a gap between the tip 94T of the blade 60 and stationary components (e.g., stators) of the turbine, and thereby, may reduce leakage flow between the rotating and stationary components. The airfoil 62, for example, the pressure side 94P thereof, may come into contact with combustion gases that are at an extremely high temperature, such as a temperature in excess of about 1200 K.

The bottom wall 92 of the dovetail 68 may include one or more air inlet apertures 96 (FIG. 3B). Further, while not illustrated in FIGS. 3A and 3B for clarity, one or more portions of the blade 60 may include cooling holes for cooling the blade 60 during operation. The cooling holes may be provided on one or more surfaces of the airfoil 62, such as the pressure side 94P, the suction side 94S, the tip 94T, the leading edge 94L, the trailing edge 94E, or a combination thereof. The cooling holes may be circular cooling holes, diffused (e.g., angled) cooling holes, cooling slots, or take on one or more other regular or irregular shapes. Cooling gas may pass through internal cooling channels (not illustrated for ease of description) in the blade 60 and emerge from the cooling holes to create a blanket of thin film over the outer surface of the airfoil 62, thus preventing direct contact of the hot gases and the surfaces of the blade 60. For example, the illustrated blade 60 has air inlet apertures 96 in the bottom wall 92 of dovetail 68. The blade 60, including the airfoil 62 thereof, may include hollow interior passages for the passage of cooling air, for example, but not limited to, from air inlet apertures 96 to cooling holes in the airfoil 62. Thus, cooling air may be bled from the compressor and channeled into the air inlet apertures 96. This air may exit out the cooling holes in one or more portions of blade 60 to cool blade 60 during operation. As embodied by the disclosure, different blades may have differing cooling schemes and air inlet apertures 96 are merely exemplary and not intended to be independently limiting.

A component of a gas turbine, such as but not limited to blade 10, vane 40, blade 60, or another turbine component, may be media blasted one or more times during manufacture or repair. When only a portion of the component is to be media blasted, the remainder of the component (or a portion of the remainder of the component) likely to come into contact with the media may be masked to reduce or preclude the likelihood that the media will impact the remaining surfaces of component. For example, when dovetail 68 of blade 60 is to be media blasted, e.g., shot peened, one or more other portions of blade 60 may be covered or otherwise shielded to reduce or preclude impact of peen to these portions from the media blasting process.

As shown in FIG. 3B, bottom wall 92 of dovetail 68 may include one or more air inlet apertures 96. When shot peening dovetail 68, or media blasting dovetail 68 using one or more other techniques, it may be desirable to seal off or otherwise mask air inlet apertures 96. Media may be blasted at the dovetail 68 proximate the air inlet apertures 96, and if these air inlet apertures 96 are not appropriately masked, media forcibly propelled onto dovetail 68 may enter air inlet apertures 96 and impact one or more internal surfaces of blade 60. It may likewise be desirable to mask portions of blade 60 that are proximate dovetail 68 to preclude impact to these portions by the media.

To avoid impact of peen to blade 60 during media blasting (e.g., shot peening) of dovetail 68, one or more surfaces of blade 60 may be masked using a masking system as embodied by the embodiments. A masking system may be manufactured using conventional techniques (such as injection molding). The masking system may be manufactured using rigid and durable materials that can suitably withstand the impact of abrasive media. However, rigid masking systems manufactured using conventional techniques (e.g., molding) may be laborious and time-consuming to fabricate. Further, masking systems manufactured using conventional molding techniques may present rigid masking systems. The blade 60, particularly in applications involving repair of blades, may not be identical to other blades 60 in the same set. For example, one blade 60 may have a different wear pattern compared to another blade 60 in the same set. For example, the airfoil 62 of one blade 60 may be worn at the tip 94T whereas the airfoil 62 of another blade 60 in the same set may additionally or alternately be worn at the leading edge 94L.

In view of even minor differences between the blades 60 of the same set, rigid masking systems may not allow for the same portion(s) of each blade 60 to be exposed or masked during the media blasting process. For example, a rigid masking system may not suitably mask and leave exposed the same portions of two blades having a slightly different wear pattern. It may be beneficial to mask components (e.g., blades 10, blades 60, vanes 40, or other components) being media blasted using masking systems that: (a) suitably mask portions of the component that are not intended to be blasted with media and which have a likelihood of being impacted by the media such as, suitably cover air inlet apertures 96 when dovetail 68 is being shot peened so media does not enter into the blade 60 via the air inlet apertures 96; and (b) can conform to different components in the same set (e.g., can conform to different blades 60 in the same set, notwithstanding minor variations from one blade 60 to the next).

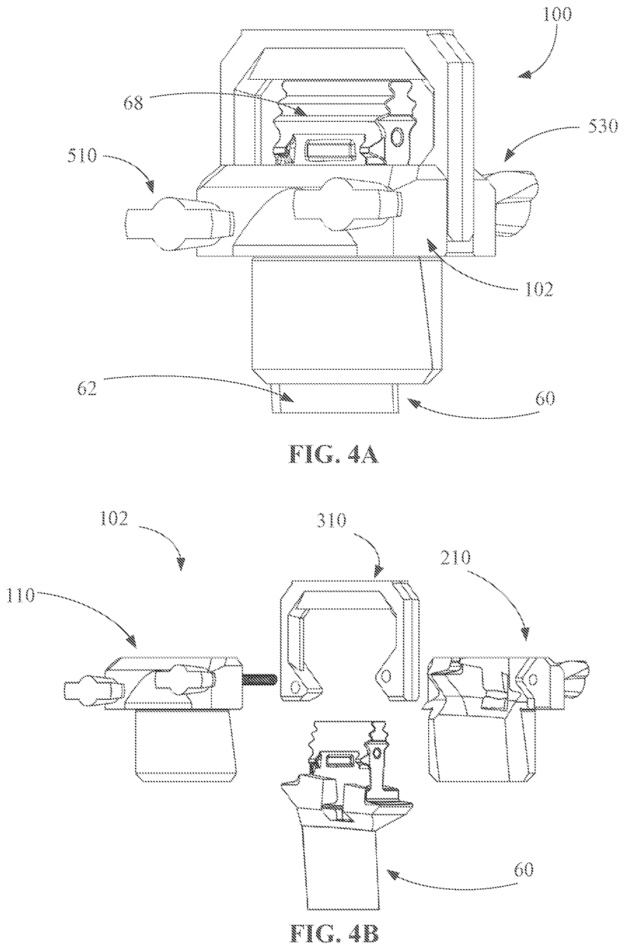

FIG. 4A shows a masking system 100, according to an aspect of the disclosure. The masking system 100 may have a housing 102 configured to mask certain portions of blade 60 (FIGS. 3A-3B) while the dovetail 68 thereof is exposed. Embodied by the disclosure, dovetail 68 may be blasted with media (e.g., may be shot peened using a shot peening apparatus) while blade 60 is retained within masking system 100. In some examples, the masking system 100 may mask all or part of the platform 66 (FIG. 3A), shank 67, and the airfoil 62 while at least the portion of dovetail 68 configured to be shot peened remains exposed and accessible to the media. In some examples, the masking system 100 may mask air inlet apertures 96 in bottom wall 92 and ensure that no media enters the blade 60 via the air inlet apertures 96.

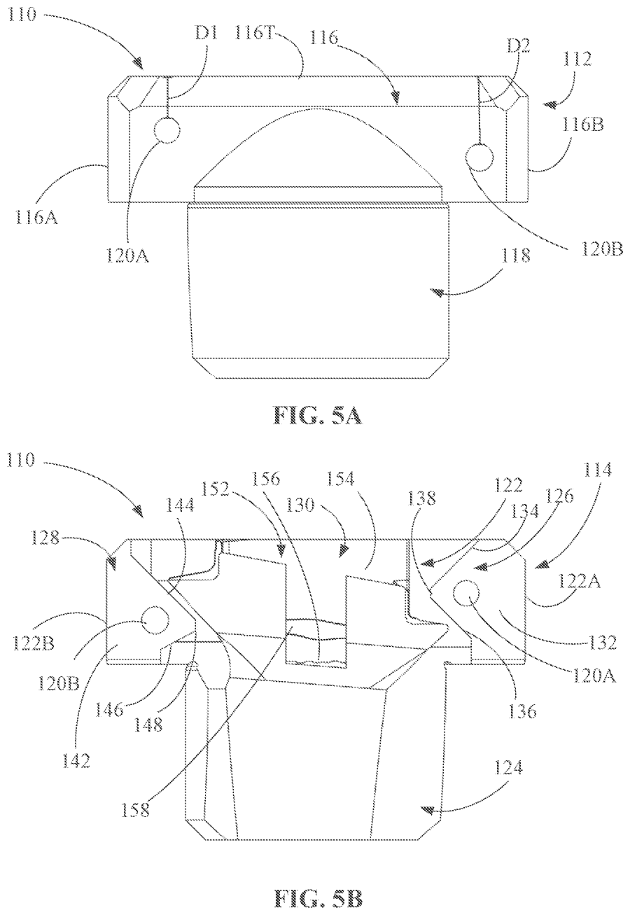

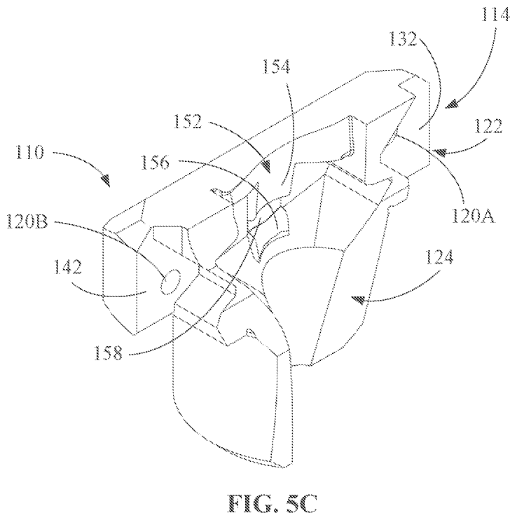

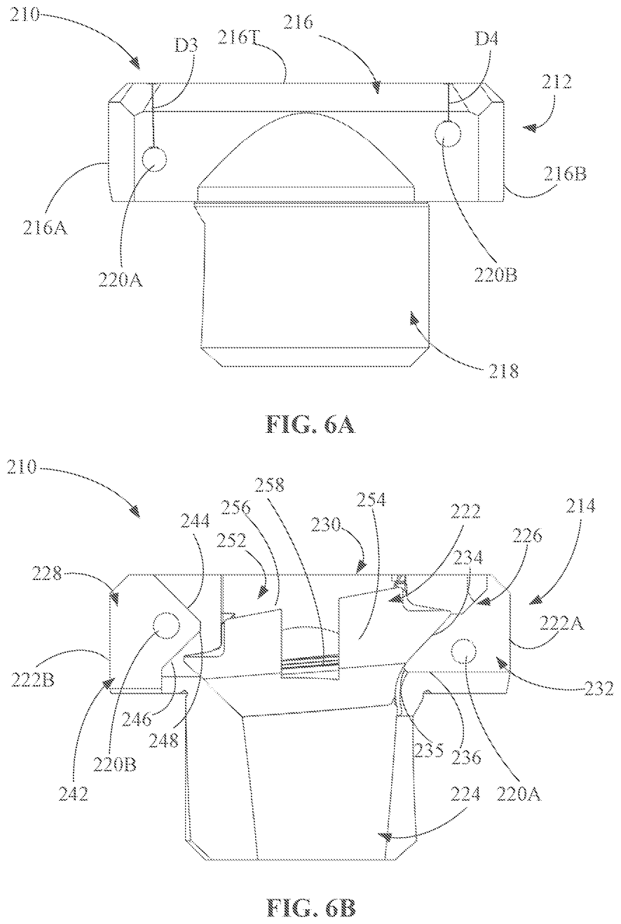

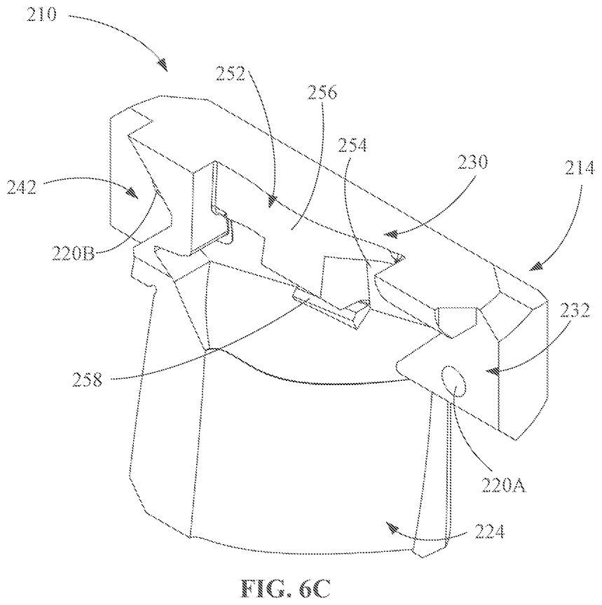

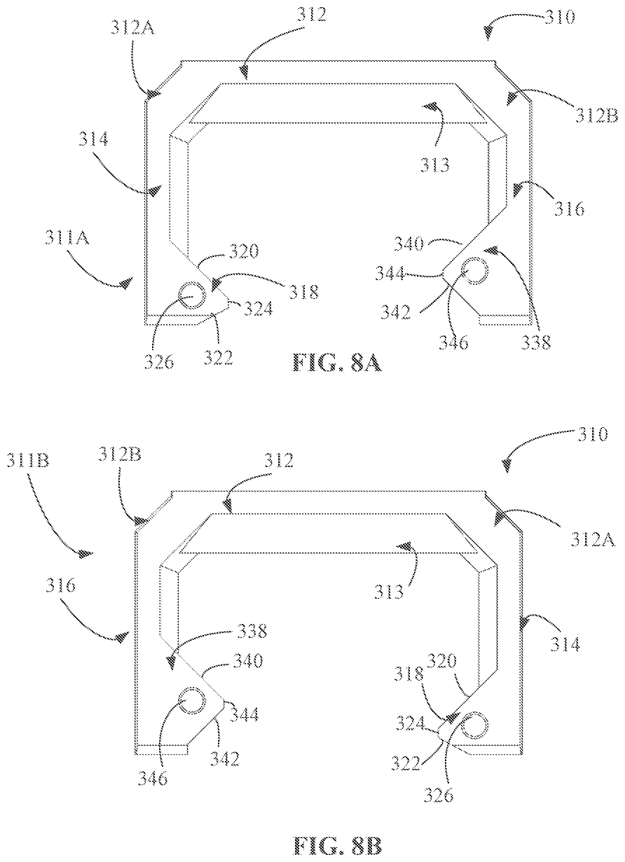

FIG. 4B shows an exploded view of housing 102 of masking system 100. Housing 102 may have a first shell 110, a second shell 210, and an intermediate member 310 that collectively form housing 102. First shell 110 is illustrated in more detail in FIGS. 5A-5C, second shell 210 is illustrated in more detail in FIGS. 6A-6C, and intermediate member 310 is illustrated in more detail in FIGS. 8A and 8B. The first shell 110, the second shell 210, and the intermediate member 310 may be securable to each other to configure the housing 102 to retain and selectively mask blade 60. Housing 102 may be configured to retain blade 60 to allow for dovetail 68 to be blasted with media (e.g., shot peened) while one or more other portions of blade 60 are shielded from the media by housing 102.

FIGS. 5A, 5B, and 5C show first shell 110 of housing 102. First shell 110 may have an outer portion 112 (FIG. 5A) and an inner portion 114 (FIGS. 5B and 5C) that opposes outer portion 112. In some examples, first shell 110 may be of a unitary construction.

Outer portion 112 of first shell 110 may include a first outer portion 116 and a second outer portion 118 that extends from first outer portion 116. In some examples, first outer portion 116 may be generally rectangular and second outer portion 118 may be generally frusto-cylindrical and convex. In other examples, either of first outer portion 116 and second outer portion 118 may be spherical, polygonal, pyramidal, or take on other regular or irregular shapes.

First outer portion 116 (FIG. 5A) may extend laterally between a first end 116A and a second end 116B of first outer portion 116. First outer portion 116, in some aspects of the disclosure, may include one or more openings. For example, first outer portion 116 may include a first opening 120A proximate first end 116A of first outer portion 116 and a second opening 120B proximate second end 116B of first outer portion 116. Each of the first opening 120A and second opening 120B may extend through first shell 110. In some aspects, first opening 120A and second opening 120B need not be vertically aligned (i.e., first opening 120A and second opening 120B may be in two different horizontal planes). For example, first opening 120A may be a first distance D1 from a top end 116T of first outer portion 116 and second opening 120B may be a second distance D2 from top end 116T of first outer portion 116. Distance D1 may be less than distance D2. In other aspects of the embodiments, distance D1 may be greater than or equal to distance D2.

Inner portion 114 (FIG. 5B), like outer portion 112, may include a first inner portion 122 and a second inner portion 124 that extends from first inner portion 122. First inner portion 122 may oppose first outer portion 116 and second inner portion 124 may oppose second outer portion 118.

First inner portion 122 may be generally rectangular. In some examples, first inner portion 122 may extend laterally between a first end 122A and a second end 122B of first inner portion 122. First end 122A and second end 122B of first inner portion 122 may be proximate or generally correspond to first end 116A and second end 116B of first outer portion 116, respectively.

First inner portion 122 may include a first terminal portion 126, a second terminal portion 128, and a central portion 130. First terminal portion 126 may extend inboard from first end 122A of first inner portion 122 and second terminal portion 128 may extend inboard from second end 122B of first inner portion 122. Central portion 130 may be disposed between first terminal portion 126 and second terminal portion 128.

First terminal portion 126 may have a first recess 132 (see FIGS. 5B and 5C). First opening 120A may extend through first recess 132. In some examples, first recess 132 may have a generally triangular profile, although in other examples, the first recess 132 may have a rectangular, spherical, or other symmetrical or asymmetrical profile or shape. First recess 132 may include a first angled wall 134 and a second angled wall 136 that each extend from a connecting wall 138. The first angled wall 134, second angled wall 136, and connecting wall 138 may form a generally frusto-triangular shape. In some examples, first angled wall 134 may extend at an angle from one end of the connecting wall 138 and second angled wall 136 may extend at an angle from the other end of connecting wall 138.

Second terminal portion 128 may be formed with a second recess 142 (see FIGS. 5B and 5C). Second opening 120B may extend through second recess 142. In some examples, second recess 142 may have a generally triangular profile, although in other examples, the second recess 142 may have a rectangular, spherical, or other symmetrical or asymmetrical profile or shape. Second recess 142 may include a first angled wall 144 and a second angled wall 146 that each extend from a connecting wall 148. The first angled wall 144, second angled wall 146, and connecting wall 148 may form a generally frusto-triangular shape. In some examples, first angled wall 144 may extend at an angle from one end of the connecting wall 148 and second angled wall 146 may extend at an angle from the other end of connecting wall 148.

The central portion 130 may include a seating area 152. Seating area 152 may be configured to seat and retain blade 60, as discussed herein (see FIG. 12B). In some aspects of the disclosure, seating area 152 may be configured to seat a portion of platform 66 and shank 67 at the pressure side 61P of blade 60. For example, seating area 152 may have recesses 154 and protrusions 156 (see FIGS. 5B and 5C) that generally correspond to portions of platform 66 and shank 67 at the pressure side 61P of blade 60, including the first recessed portion 72 (FIG. 3A) of blade 60. In some examples, seating area 152 may have a slot 158 (FIG. 5C) that generally corresponds to and is configured to accept the shelf 74A (FIG. 3A) of blade 60 on pressure side 61P thereof.

First shell 110 may have a first seating area configured to seat at least a first part of a first side of the component. First seating area may include or correspond to seating area 152 (see FIG. 5C) or another seating area. The component may include one or more of blade 60, blade 10, vane 40, a different gas turbine component, or another component. The first side of the component may include one or more of a suction side of the component, a pressure side of the component, or another side of the component. Where the component is a gas turbine blade, such as blade 60, the first part may include one or more portions of platform 66, shank 67, airfoil 62, or another part of the component. Where the component is a different component, the first part may include one or more other portions of the component.

FIGS. 6A, 6B, and 6C show second shell 210 of housing 102. Second shell 210 may have an outer portion 212 (FIG. 6A) and an inner portion 214 (FIGS. 6B and 6C) that opposes outer portion 212.

Outer portion 212 of second shell 210 may include a first outer portion 216 and a second outer portion 218 that extends from first outer portion 216. In some examples, first outer portion 216 may be generally rectangular and second outer portion 218 may be generally frusto-cylindrical and convex. In other examples, either of first outer portion 216 and second outer portion 218 may be spherical, polygonal, pyramidal, or formed in other regular or irregular shapes.

First outer portion 216 (FIG. 6A) may extend laterally between a first end 216A and a second end 216B of first outer portion 216. First outer portion 216, in some aspects of the disclosure, may include one or more openings. For example, first outer portion 216 may include a first opening 220A proximate first end 216A of first outer portion 216 and a second opening 220B proximate second end 216B of first outer portion 216. Each of the first opening 220A and second opening 220B may extend through second shell 210. In some aspects, first opening 220A and second opening 220B need not be vertically aligned (i.e., first opening 220A and second opening 220B may be in two different horizontal planes). For example, first opening 220A may be a first distance D3 from a top end 216T of first outer portion 216 and second opening 220B may be a second distance D4 from top end 216T of first outer portion 216. Distance D4 may be less than distance D3. In other embodiments, distance D4 may be greater than or equal to distance D3. In some examples, distance D3 may generally correspond to distance D2 (FIG. 5A) discussed above with respect to first shell 110, and distance D4 may generally correspond to distance D1 discussed above with respect to first shell 110.

Inner portion 214 (FIG. 6B), like outer portion 212, may include a first inner portion 222 and a second inner portion 224 that extends from first inner portion 222. First inner portion 222 may oppose first outer portion 216 and second inner portion 224 may oppose second outer portion 218.

First inner portion 222 may be generally rectangular. In some examples, first inner portion 222 may extend laterally between a first end 222A and a second end 222B of first inner portion 222. First end 222A and second end 222B of first inner portion 222 may be proximate or generally correspond to first end 216A and second end 216B of first outer portion 216, respectively.

First inner portion 222 of second shell 210, similar to first inner portion 122 of first shell 110, may include a first terminal portion 226, a second terminal portion 228, and a central portion 230. First terminal portion 226 may extend inboard from first end 222A of first inner portion 222 and second terminal portion 228 may extend inboard from second end 222B of first inner portion 222. Central portion 230 may be disposed between first terminal portion 226 and second terminal portion 228.

First terminal portion 226 may have a second recess 232 (see FIGS. 6B and 6C). First opening 220A may extend through second recess 232. In some examples, second recess 232 may have a generally triangular profile, although in other examples, the second recess 232 may have a rectangular, spherical, or other symmetrical or asymmetrical profile or shape. Second recess 232 may include a first angled wall 234 and a second angled wall 236 that each extend at an angle from a connecting wall 235. The first angled wall 234, second angled wall 236, and connecting wall 235 may collectively form a generally triangular or frusto-triangular shape.

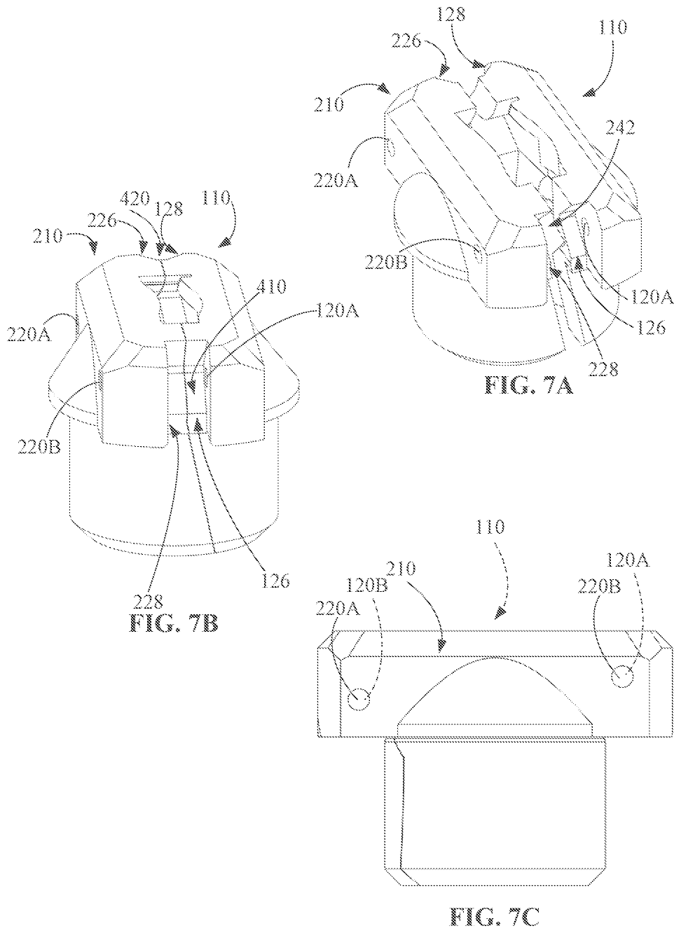

Second terminal portion 228 may have a first recess 242 (see FIGS. 6B, 6C, and 7A). Second opening 220B may extend through first recess 242. In some examples, first recess 242 may have a generally triangular profile, although in other examples, the first recess 242 may have a rectangular, spherical, or other symmetrical or asymmetrical profile or shape. First recess 242 may include a first angled wall 244 and a second angled wall 246 that extend from a connecting wall 248. The first angled wall 244, second angled wall 246, and connecting wall 248 may form a generally frusto-triangular shape. In some examples, first angled wall 244 may extend at an angle from one end of the connecting wall 248 and second angled wall 246 may extend at an angle from the other end of connecting wall 248.

The central portion 230 may include a seating area 252. Seating area 252 may be configured to seat and retain blade 60. As noted, seating area 152 of first shell 110 may be configured to seat a portion of platform 66 and shank 67 at the pressure side 61P of blade 60. Conversely, seating area 252 of second shell 210 may be configured to seat a portion of platform 66 and shank 67 at the suction side 61S of blade 60. For example, seating area 252 may have recesses 254 and protrusions 256 (see also FIG. 6C) that generally correspond to portions of platform 66 and shank 67 at the suction side 61S of blade 60, including the second recessed portion 82 (FIG. 3B) of blade 60. In some examples, seating area may have a slot 258 that generally corresponds to and is configured to accept the shelf 84A (FIG. 3B) of blade 60 on suction side 61S thereof.

Second shell 210 may have a second seating area configured to seat at least a second part of a second side of the component. Second seating area may include or correspond to seating area 252 (see FIG. 6C) or another seating area. The component may include one or more of blade 60, blade 10, vane 40, a different gas turbine component, or another component. The first side of the component may include one or more of a suction side of the component, a pressure side of the component, or another side of the component. Where the component is a gas turbine blade, such as blade 60, the second part may include one or more portions of platform 66, shank 67, airfoil 62, or another part of the component. Where the component is a different component, the second part may include one or more other portions of the component.

In certain aspects of the embodiments, first shell 110 and second shell 210 may be configured to be coupled (e.g., secured) to each other (together with the intermediate member 310, as discussed herein). FIG. 7A shows the first shell 110 and second shell 210 in proximity with each other prior to securement and FIG. 7B shows the first shell 110 and second shell 210 in contact with each other for securement. As can be seen in FIGS. 7A and 7B, when first shell 110 and second shell 210 are mated or otherwise brought into contact with each other for securement: (a) a first receiving area 410 is formed between first terminal portion 126 (FIG. 5B) of first shell 110 and second terminal portion 228 (FIG. 6B) of second shell 210; and (b) a second receiving area 420 is formed between second terminal portion 128 of first shell 110 and first terminal portion 226 of second shell 210. More specifically: (a) first recess 132 (FIG. 5B) of first terminal portion 126 of first shell 110 and first recess 242 (FIG. 6B) of second terminal portion 228 of second shell 210 may collectively form first receiving area 410; and (b) second recess 142 of second terminal portion 128 of first shell 110 and second recess 232 of first terminal portion 226 of second shell 210 may collectively form second receiving area 420. As shown in FIG. 7C, when first shell 110 and second shell 210 are so configured, first opening 120A of first shell 110 corresponds to and aligns with second opening 220B of second shell 210, and second opening 120B of first shell 110 corresponds to and aligns with first opening 220A of second shell 210.

FIGS. 8A and 8B respectively show a first side 311A and an opposing second side 311B of intermediate member 310. Intermediate member 310 may, in some examples, be generally U-shaped. In other examples, intermediate member 310 may be squared, rectangular, pyramidal, or take on other symmetrical or asymmetrical shapes.

In some aspects of the disclosure, intermediate member 310 may have a first portion 312, a second portion 314, and a third portion 316. In some examples, first portion 312 may extend generally laterally and have opposing angled ends 312A and 312B. In some examples, second portion 314 may extend vertically downwards from angled end 312A and third portion 316 may extend vertically downwards from angled end 312B. First portion 312 of intermediate member 310 may include a plugging member 313 that extends laterally between angled ends 312A and 312B. As discussed herein, plugging member 313 may plug or seal air inlet apertures of a component masked by the masking system 100 (such as air inlet apertures 96 of blade 60).

Second portion 314, at a distal end thereof, may include a first projection 318 that projects towards third portion 316. First projection 318, in some examples of the disclosure, may be generally triangular or frusto-triangular. In other examples, first projection 318 may take on other shapes, such as a square shape, a rectangular shape, a cylindrical shape, or other symmetrical or asymmetrical shape.

First projection 318 may, in some examples, include a first angled wall 320, a second angled wall 322, and a connecting wall 324. First angled wall 320 may extend at an angle from one end of the connecting wall 324 and second angled wall 322 may extend at an angle from the other end of the connecting wall 324. The first angled wall 320, second angled wall 322, and connecting wall 324 may collectively form a generally frusto-triangular shape. In some examples, first projection 318 may have a first opening 326 that extends through first projection 318.

Third portion 316, at a distal end of third portion 316, may include a second projection 338 that projects towards second portion 314. Second projection 338, in some examples of the disclosure, may be generally triangular or frusto-triangular. In other examples, second projection 338 may take on other shapes, such as a square shape, a rectangular shape, a cylindrical shape, or other symmetrical or asymmetrical shape.

Second projection 338 may, in some examples, include a first angled wall 340, a second angled wall 342, and a connecting wall 344. First angled wall 340 may extend at an angle from one end of the connecting wall 344 and second angled wall 342 may extend at an angle from the other end of the connecting wall 344. The first angled wall 340, second angled wall 342, and connecting wall 344 may collectively form a generally frusto-triangular shape. In some examples, second projection 338 may have a second opening 346 that extends through second projection 338.

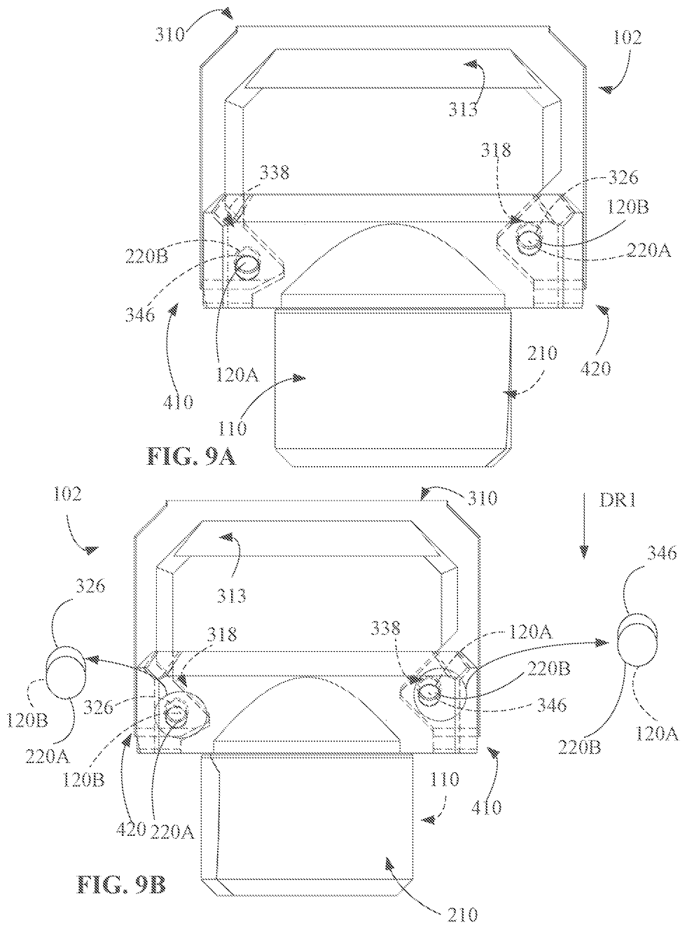

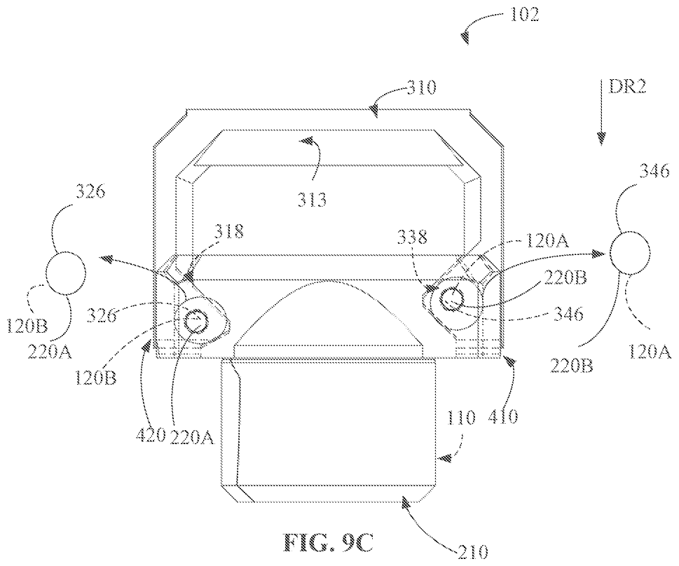

The intermediate member 310 may be configured to be secured to first shell 110 and second shell 210 such that first projection 318 and second projection 338 of intermediate member 310 are between first shell 110 and second shell 210. In some examples, and as shown in FIGS. 9A and 9B, first projection 318 of intermediate member 310 may be configured to be received within second receiving area 420 (see FIG. 7B) that is formed when first shell 110 and second shell 210 are brought together for securement. Similarly, second projection 338 of intermediate member 310 may be configured to be received within first receiving area 410 (see FIG. 7B) that is formed when first shell 110 and second shell 210 are brought together for securement.

In some examples, when the intermediate member 310, and specifically the first projection 318 and second projection 338, are respectively received within the second receiving area 420 and first receiving area 410, the openings in intermediate member 310 do not fully align with corresponding openings in first shell 110 and second shell 210. Specifically, as shown more clearly in FIG. 9B, when first projection 318 of intermediate member 310 is received within second receiving area 420, first opening 326 of first projection 318 of intermediate member 310 may not align fully with second opening 120B of first shell 110 and first opening 220A of second shell 210. That is, while second opening 120B of first shell 110 and first opening 220A of second shell 210 may align with each other, first opening 326 of intermediate member 310 may intersect second opening 120B and first opening 220A and not fully align therewith.

Similarly, when second projection 338 of intermediate member 310 is received within first receiving area 410, second opening 346 of second projection 338 of intermediate member 310 may not line up with first opening 120A of first shell 110 and second opening 220B of second shell 210. That is, while first opening 120A of first shell 110 and second opening 220B of second shell 210 may align with each other, second opening 346 of intermediate member 310 may intersect first opening 120A and second opening 220B and not fully align therewith. The first opening 326 and second opening 346 of intermediate member 310 may be made to align with corresponding openings of first shell 110 and second shell 210 by pushing intermediate member 310 in a direction DR1 while the first projection 318 and second projection 338 are seated within second receiving area 420 and first receiving area 410, respectively.

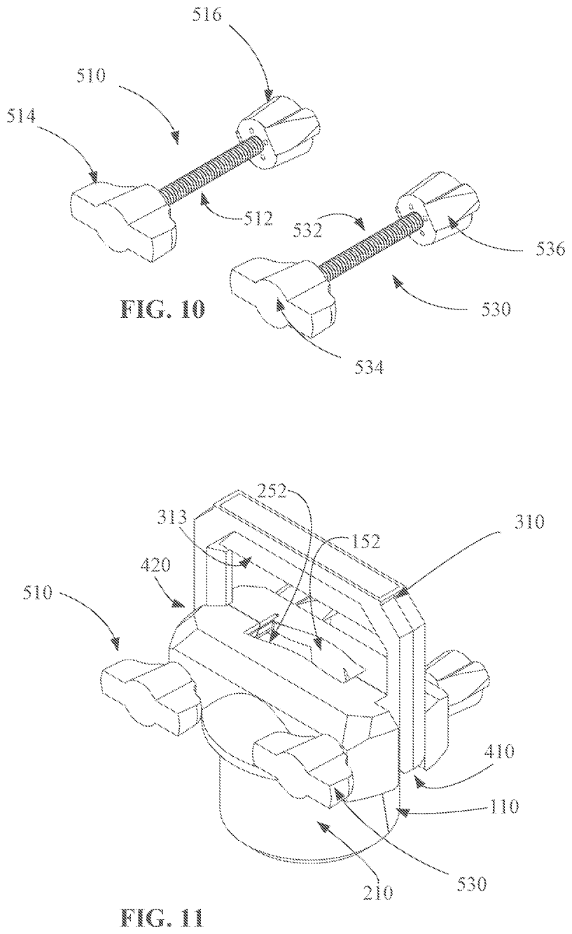

FIG. 10 shows example fastening systems 510 and 530 that may be usable to fasten first shell 110, second shell 210, and intermediate member 310 together. Fastening systems 510 and 530 are example systems and are not intended to limit the embodiments in any manner. Any suitable fastening system, now known or hereafter developed, may be used to fasten first shell 110, second shell 210, and intermediate member 310 together.

In some examples, fastening system 510 may include a bolt 512 and nuts 514 and 516. Bolt 512 may, in certain examples, be headless and threaded. In some examples, fastening system 510 or portions thereof may be made with elastomeric materials (e.g., silicone or other suitable elastomeric materials) as such may allow fastening system 510 to provide a secure seal relative to conventional fastening systems that are made of rigid materials. In some examples, fastening system 510 or portions thereof may be coated with fluoropolymers and/or other materials for increased strength and durability.

Fastening system 530 may include a bolt 532 and nuts 534 and 536. Bolt 532 may be headless and threaded. In some examples, fastening system 530 or portions thereof may be made with elastomeric materials and/or may be coated. In some non-limiting examples, fastening system 530 may be generally identical to fastening system 510.

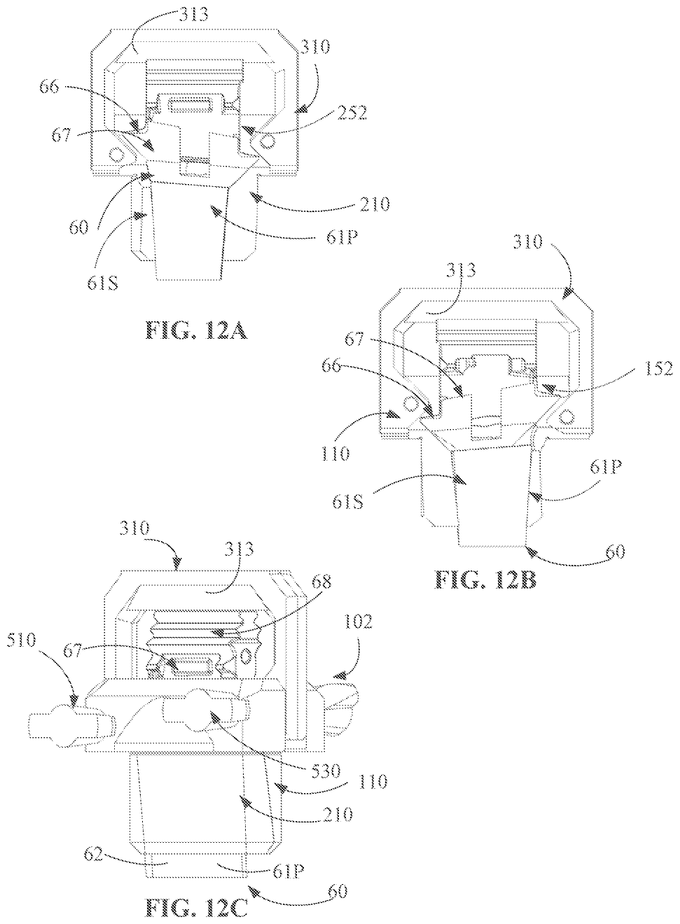

As shown in FIG. 11, fastening systems 510 and 530 may be used to secure first shell 110, second shell 210, and intermediate member 310 together. For example, one of bolt 512 of fastening system 510 and bolt 532 of fastening system 530 may be passed through each of first opening 220A (FIG. 9B) of second shell 210, second opening 120B (FIG. 9B) of first shell 110, and first opening 326 of intermediate member 310. The other of bolt 512 of fastening system 510 and bolt 532 of fastening system 530 may be passed through each of second opening 220B (FIG. 9B) of second shell 210, first opening 120A (FIG. 9B) of first shell 110, and second opening 346 of intermediate member 310.

As discussed above with reference to FIG. 9B, when the first projection 318 and second projection 338 of intermediate member 310 are respectively received within second receiving area 420 and first receiving area 410: (a) the first opening 326 of first projection 318 of intermediate member 310 may not align fully with second opening 120B of first shell 110 and first opening 220A of second shell 210; and (b) second opening 346 of second projection 338 of intermediate member 310 may not align fully with first opening 120A of first shell 110 and second opening 220B of second shell 210. As one of bolt 512 of fastening system 510 and bolt 532 of fastening system 530 is inserted into first opening 326 of intermediate member 310, second opening 120B of first shell 110, and first opening 220A of second shell 210, and the other of bolt 512 and bolt 532 is inserted into second opening 346 of intermediate member 310, first opening 120A of first shell 110, and second opening 220B of second shell 210, the bolts 512 and 532 may pull the intermediate member 310 in direction D and forcibly align: (a) first opening 326 of intermediate member 310 with second opening 120B of first shell 110 and first opening 220A of second shell 210; and (b) second opening 346 of intermediate member 310 with first opening 120A of first shell 110 and second opening 220B of second shell 210. As the nuts 514 and 516 of fastening system 510 and nuts 534 and 536 of fastening system 530 are tightened, the fastening systems 510 and 530 may lock the intermediate member 310 with first shell 110 and second shell 210 such that the first opening 326 and second opening 346 of intermediate member 310 are aligned with corresponding openings of first shell 110 and second shell 210. As noted, alignment of these respective openings may be associated with translation of intermediate member 310 in a direction DR1. That is, as the bolts 512 and 532 are inserted in a direction perpendicular to direction DR1 (FIG. 9B), the intermediate member 310 may forcibly be moved in direction DR1. Fastening of the first shell 110, second shell 210, and intermediate member 310 using fastening systems 510 and 530 may therefore be associated with movement of first shell 110 and second shell 210 towards each other in a direction perpendicular to direction DR1 and movement of intermediate member 310 in direction DR1. As discussed herein, translation of intermediate member 310 in direction DR1 may cause plugging member 313 to also travel in direction DR1 and seal air inlet apertures 96 of blade 60 when blade 60 is seated within first shell 110 and second shell 210.

FIG. 9C shows housing 102 after fastening systems 510 and 530 have been fastened to secure first shell 110, second shell 210, and intermediate member 310 (fastening systems 510 and 530 are not shown in FIG. 9C for clarity). As can be seen, when first shell 110, second shell 210, and intermediate member 310 are secured together using the fastening systems 510 and 530, (a) first opening 326 of intermediate member 310, second opening 120B of first shell 110, and first opening 220A of second shell 210 align with each other; and (b) second opening 346 of intermediate member 310, first opening 120A of first shell 110, and second opening 220B of second shell 210 align with each other.

FIG. 12A shows blade 60, and specifically portions of platform 66 and shank 67 on suction side 61S thereof, being seated in seating area 252 of second shell 210. Similarly, FIG. 12B shows blade 60, and specifically portions of platform 66 and shank 67 on pressure side 61P thereof, being seated in seating area 152 of first shell 110. FIG. 12C shows first shell 110, second shell 210, and intermediate member 310 secured to each other using fastening systems 510 and 530 to form housing 102. Housing 102 is shown retaining blade 60 such that certain areas of blade 60 (e.g., portions of dovetail 68 and shank 67) are exposed whereas one or more other portions of blade 60 are masked by housing 102. In some examples, intermediate member 310, and specifically the plugging member 313 thereof, may seal air inlet apertures 96 (not visible in FIG. 12C) of blade 60 when intermediate member 310 is fastened to first shell 110 and second shell 210 (as discussed, intermediate member 310 may be pulled in direction DR1 when intermediate member 310 is fastened to first shell 110 and second shell 210 via fastening systems 510 and 530, and thereby seal or plug the air inlet apertures 96 of blade 60). Advantageously, thus, when first shell 110 and second shell 210 are secured to intermediate member 310 to retain blade 60, media may not enter the blade 60 through air inlet apertures 96 or contract surfaces of blade 60 not intended to be blasted with media.

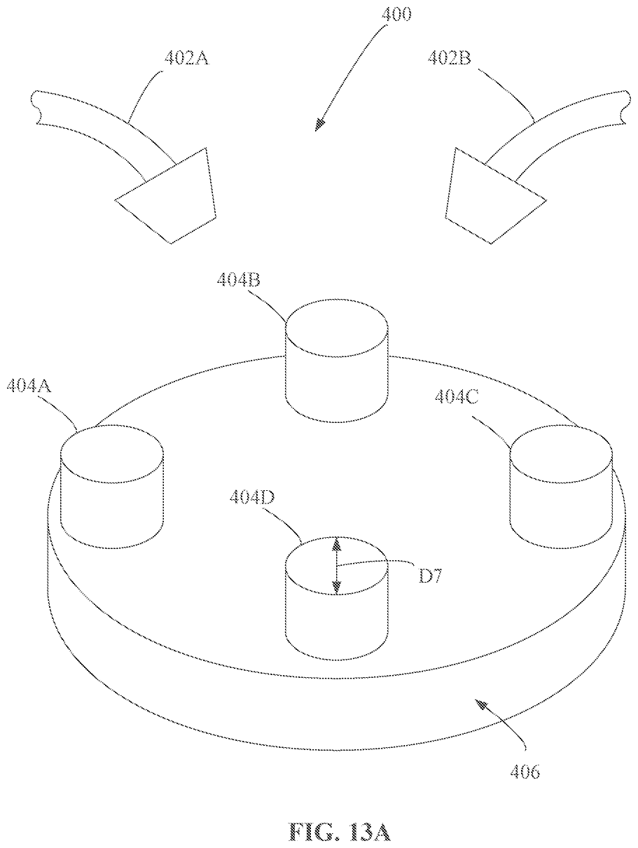

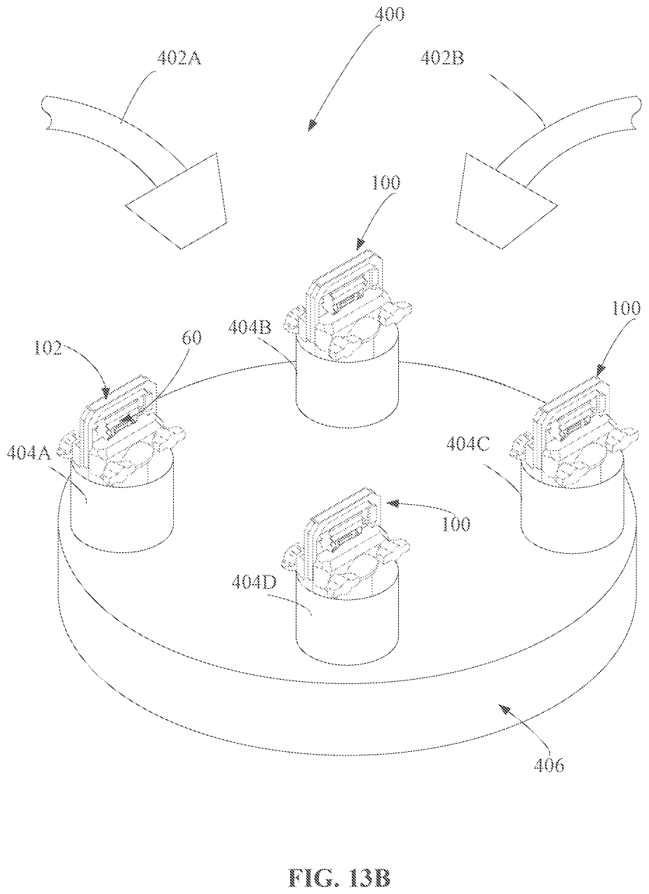

FIG. 13A shows an example schematic illustration of a shot peen apparatus 400, according to one aspect of the disclosure. Shot peen apparatus 400 may have one or more shot peen nozzles and one or more cans or holders. The illustrated embodiment has two shot peen nozzles 402A and 402B and four cans 404A, 404B, 404C, and 404D, although additional or fewer shot peen nozzles or cans may be provided. The cans 404A-404D may be situated on a tray 406. In some examples, the tray 406 may be rotatable (e.g., may be coupled to a motor (not shown for clarity)) and each can 404A-404D may also individually rotate. A component, such as blade 60, or another component to be shot peened, may be situated in each of the cans 404A-404D. The shot peen nozzles 402A and 402B may eject shots at high pressure as the cans 404A-404D and the tray 406 rotate to allow different surfaces of the component to be bombarded by the media. The shots may strike the component situated in each can 404A-404D and peen exposed surfaces of the component.

FIG. 13B shows the shot peen apparatus 400 being used to shot peen blades 60. As can be seen, a masking system 100, with a blade 60 retained therein, may be disposed within each of the cans 404A-404D. The masking system 100 may shield portions of the blade 60 not intended to be shot peened while exposing portions of dovetail 68 and shank 67 (see FIGS. 3A-3B) to media. Once a masking system 100 together with a blade 60 is disposed in each of the cans 404A-404D, the shot peen nozzles 402A and 402B may be used to eject shots at a high pressure to peen the surfaces of the dovetail 68 and shank 67. Once the shot peening process is complete, the masking systems 100 may be removed from the respective cans 404A-404D. First shell 110 of each masking system 100 may be uncoupled from second shell 210 and intermediate member 310 thereof by unfastening fastening systems 510 and 530, and the blade 60 may be removed. In this manner, masking system 100 may allow for selective masking of a component blasted with abrasive media.

In some non-limiting examples, one or more portions of the masking system 100, or the entire masking system 100, may be additively manufactured. Additive manufacturing, also referred to as 3D printing, may be performed by dividing the shape of a three-dimensional object, i.e., the masking system 100 in this example, into a number of two-dimensional cross sections having a uniform or variable thickness, and forming the two-dimensional cross sections to be stacked one by one. There are several known additive printing methods such as a material extrusion method, a material jetting method, a binder jetting method, a sheet lamination method, a vat photo-polymerization method, a powder bed fusion method, a directed energy deposition (DED) method, et cetera. Any one or more of these methods, or any other additive manufacturing method, now known or hereinafter developed, may be employed to manufacture the masking system 100, including the first shell 110, second shell 210, intermediate member 310, and fastening systems 510 and 530.

In some examples, the masking system 100 may be manufactured using vat photo-polymerization. Vat photopolymerization, such as stereolithography, direct light processing, continuous liquid interface production, solid ground curing, et cetera, is a category of additive manufacturing processes that create three dimensional objects by selectively curing material (e.g., resin or other photopolymers) through targeted light-activated polymerization. When exposed to certain wavelengths of light, the liquid photopolymers' molecules may rapidly bind together and cure into a solid state through a process called photopolymerization. The liquid photopolymer(s) may be held in a container or vat with the build platform partially submerged near the surface of the liquid. Using the information supplied by a CAD or other design file, the printer may direct a light source to selectively cure the liquid photopolymer into a solid layer. Then the build platform may then be re-submerged into the remaining resin and the process may be repeated for the next layers until the masking system 100 has been fully printed.

In an example of the disclosure, the masking system 100 (e.g., first shell 110, second shell 210, and intermediate member 310) may be additively manufactured using silicone elastomers having a shore hardness in a range between about 50 and about 90 A. In some examples, IND402 from Loctite® may be used to additively manufacture masking system 100. In other examples, elastomeric three-dimensional printable polymers (e.g., resins, pellets, filaments, powders, and similar materials) that provide a minimum shore hardness of about 75 A, a minimum energy return of about 33%, and a minimum tear strength of about 28 kN/m, may be used to additively manufacture masking system 100.

In some examples, one or more portions of masking system 100 may be filled with a strengthening material. For examples, in some aspects of the disclosure, intermediate member 310 may be filled with urethane, silicone, or another strengthening material.

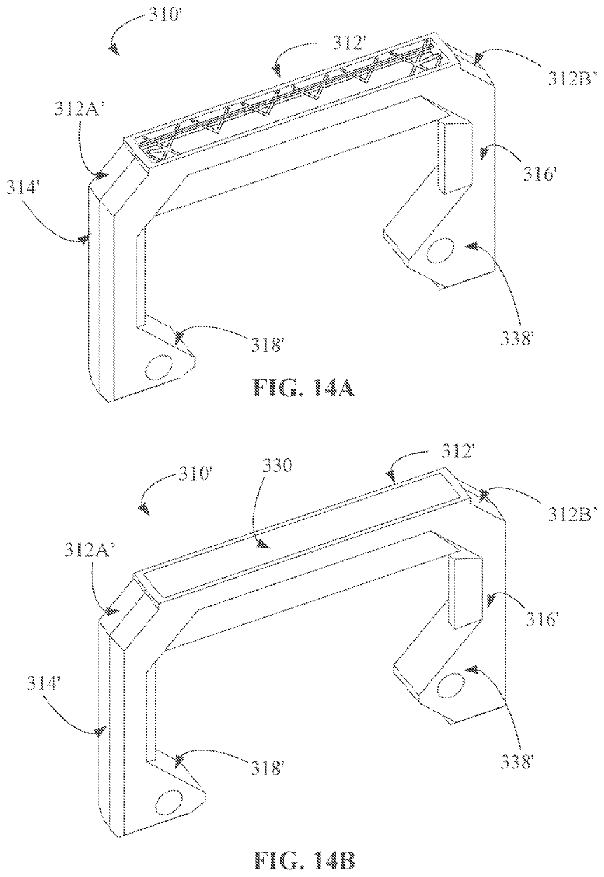

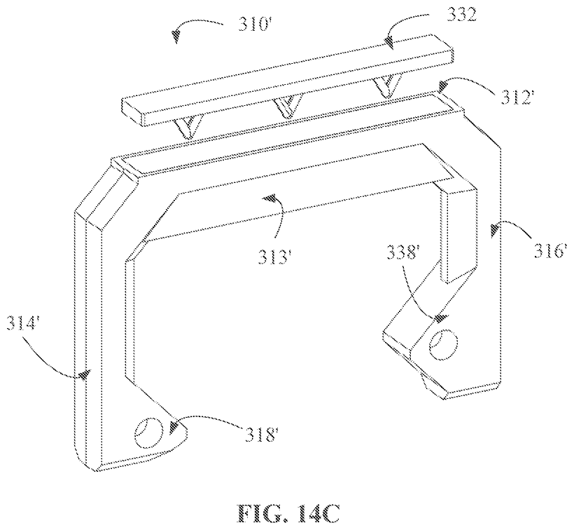

FIG. 14A shows intermediate member 310′. Intermediate member 310′ may be an alternate embodiment of intermediate member 310, and may be similar to intermediate member 310, except as noted and/or shown. Corresponding reference numerals may be used to denote corresponding parts, though with any noted deviations.

Intermediate member 310′ may, in some examples, replace intermediate member 310 in masking system 100. As discussed above, intermediate member 310 may include a first portion 312 having opposing angled ends 312A and 312B, and a second portion 314 and a third portion 316 that respectively extend from angled end 312A and 312B. Intermediate member 310′ may likewise include a first portion 312′ having opposing angled ends 312A′ and 312B′, and a second portion 314′ and a third portion 316′ that respectively extend from angled end 312A′ and 312B′. Much like intermediate member 310, second portion 314′ may include a projection 318′ and third portion 316′ may include a projection 338′. Intermediate member 310′ may further have a plugging member 313′ that generally corresponds to plugging member 313. One difference between intermediate member 310 and intermediate member 310′ may be that intermediate member 310′ may be hollow and may be configured to be filled with a strengthening material 330. For example, as shown in FIG. 14C, first portion 312′ may include a removable cap 332 that may be removed to access the hollow interior of the intermediate member 310′. Each of the angled ends 312A′ and 312B′, and the second portion 314′ and third portion 316′, may be hollow.

As shown in FIG. 14B, the hollow interior of intermediate member 310′ may be filled with strengthening material 330. The strengthening material 330 may be, e.g., urethane, silicone, or another suitable strengthening material. In some examples, one or more of each of first portion 312′, second portion 314′, third portion 316′, and angled ends 312A′ and 312B′ may be filled or partially filled with strengthening material 330. As will be appreciated, when shot peening blade 60 retained within housing 102, intermediate member 310′, due to its proximity to dovetail 68 and shank 67, may be bombarded with media. Strengthening the intermediate member 310′ with strengthening material 330 may increase the durability of intermediate member 310′ and enable it to withstand media for a plurality of shot peening cycles associated with a plurality of blades 60.

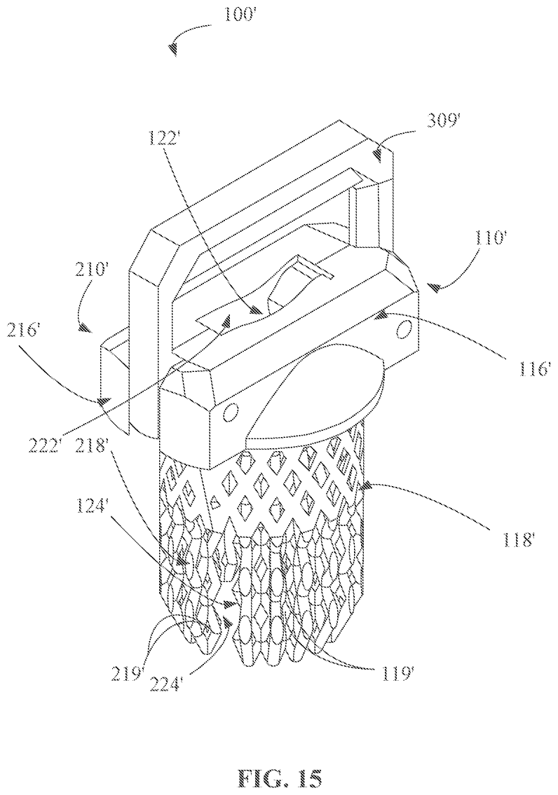

FIG. 15 shows a masking system 100′, according to certain aspects of the disclosure. Masking system 100′ may be similar to masking system 100 except as noted and/or shown. Corresponding reference numbers may be used to indicate corresponding parts, though with any noted deviations.

Masking system 100′, like masking system 100, may include a first shell 110′, a second shell 210′, and an intermediate member 309′. As discussed above for masking system 100, first shell 110 may include a first outer portion 116, a second outer portion 118 that extends from first outer portion 116, a first inner portion 122 that opposes first outer portion 116, and a second inner portion 124 that opposes second outer portion 118 (see FIGS. 5A-5C). First shell 110′ (FIG. 15) may likewise include a first outer portion 116′, a second outer portion 118′ that extends from first outer portion 116′, a first inner portion 122′ that opposes first outer portion 116′, and a second inner portion 124′ that opposes second outer portion 118′. First outer portion 116′ and first inner portion 122′ of first shell 110′ may be generally identical or similar to first outer portion 116 and first inner portion 122 of first shell 110, respectively. One difference between first shell 110 and first shell 110′ may be that second outer portion 118′ and second inner portion 124′ of first shell 110′, unlike second outer portion 118 and second inner portion 124 of first shell 110, may be webbed or netted. For example, as shown in FIG. 15, second outer portion 118′ and second inner portion 124′ may include a lattice structure having openings 119′ that extend through the second outer portion 118′ and second inner portion 124′. The lattice structure of the second outer portion 118′ and second inner portion 124′ may allow the second outer portion 118′ and second inner portion 124′ to be fabricated using fewer raw materials relative to second outer portion 118 and second inner portion 124.

In the same vein, and as discussed above, second shell 210 may include a first outer portion 216, a second outer portion 218 that extends from first outer portion 216, a first inner portion 222 that opposes first outer portion 216, and a second inner portion 224 that opposes second outer portion 218 (see FIGS. 6A-6C). Second shell 210′ (FIG. 15) may likewise include a first outer portion 216′, a second outer portion 218′ that extends from first outer portion 216′, a first inner portion 222′ that opposes first outer portion 216′, and a second inner portion 224′ that opposes second outer portion 218′. First outer portion 216′ and first inner portion 222′ of second shell 210′ may be generally identical or similar to first outer portion 216 and first inner portion 222 of second shell 210, respectively. One difference between second shell 210 and second shell 210′ may be that second outer portion 218′ and second inner portion 224′ of second shell 210′, unlike second outer portion 218 and second inner portion 224 of second shell 210, may be webbed or netted. For example, as shown in FIG. 15, second outer portion 218′ and second inner portion 224′ may include a lattice structure having openings 219′ that extend through the second outer portion 218′ and second inner portion 224′. The lattice structure of the second outer portion 218′ and second inner portion 224′ may allow the second outer portion 218′ and second inner portion 224′ to be fabricated using fewer raw materials relative to second outer portion 218 and second inner portion 224.

The intermediate member 309′ may be generally identical to or similar to intermediate member 310 or intermediate member 310′ discussed above for masking system 100. The intermediate member 309′ may be secured to first shell 110′ and second shell 210′ using fastening systems 510 and 530 as discussed above for masking system 100. In some examples, masking system 100 and masking system 100′ may be generally identical except that portions of first shell 110′ and second shell 210′ may include a lattice or webbed structure.

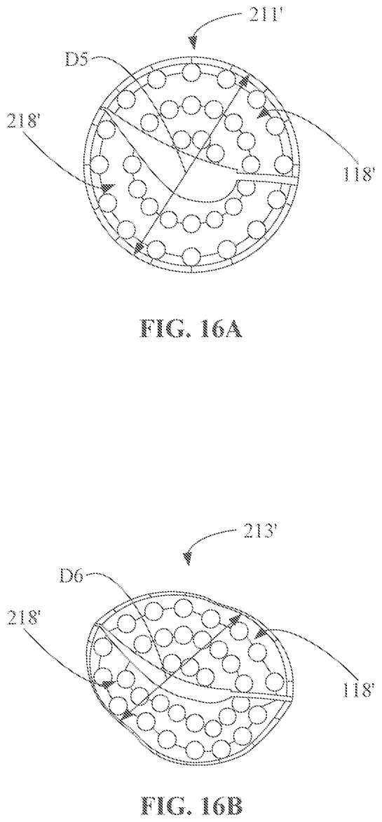

FIG. 16A shows the second outer portion 118′ of first shell 110′ and second outer portion 218′ of second shell 210′ in a resting or initial state 211′. In the initial state 211′, the outer portions 118′ and 218′ may collectively form a generally circular shape having a diameter D5. FIG. 16B shows the outer portions 118′ and 218′ in a compressed state 213′. In the compressed state 213′, the outer portions 118′ and 218′ may collectively form a generally circular shape having a diameter D6. Diameter D6 may be less than diameter D5.

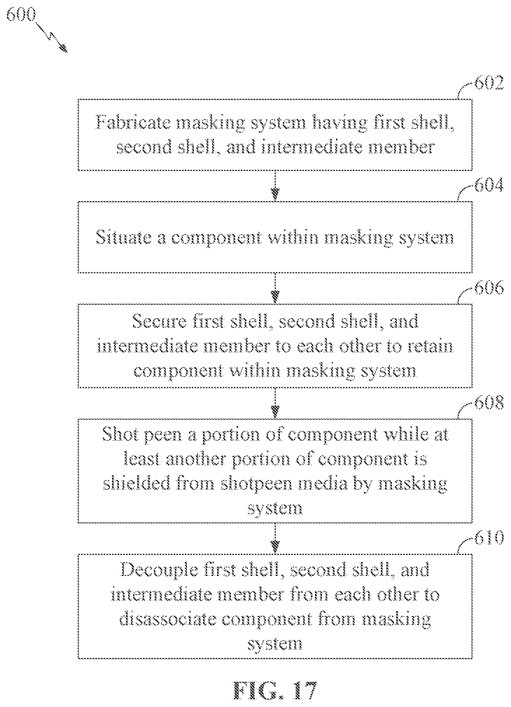

In some examples, each can 404A-404D of shot peen apparatus 400 may have a diameter D7 (see FIG. 13A). Diameter D5 may be greater than diameter D7—that is, in the initial (or uncompressed) state 211′, the outer portions 118′ and 218′ may be oversized relative to a respective can 404A-404D of shot peen apparatus 400. The outer portions 118′ and 218′ may be compressed or squeezed to be made to fit within a can 404A-404D. Once inside one of the cans 404A-404D, the outer portions 118′ and 218′ may decompress and push against interior surfaces of the associated can 404A-404D and be secured therein. Such may ensure that the masking system 100′ does not move relative to the respective can 404A-404D while the shot peen apparatus 400 is being used to blast media on the blade 60, which may increase the consistency of the media blasting operation. The reduction of material associated with the lattice structure of the second outer portions 118′ and 218′ and second inner portions 124′ and 224′ may allow these portions to be readily compressed to fit within a can 404A-404D. FIG. 17 is a flowchart illustrating a method 600 of making and using the masking systems disclosed herein (e.g., masking system 100, masking system 100′, et cetera) to mask a component, such as blade 60 or another component. At step 602, a masking system may be fabricated. For example, a masking system having a first shell, a second shell, an intermediate member, and fastening systems may be additively manufactured. In other examples, one or more portions of the masking system may be manufactured using injection molding or other conventional techniques.

At step 604, a component may be situated within a housing of the masking system. At step 606, the first shell, second shell, and intermediate member may be secured to each other such that the component is retained within the housing of the masking system. As discussed above, securement of first shell, second shell, and intermediate member may pull the intermediate member towards the first shell and the second shell to cause the intermediate member to seal off air inlet apertures of the component. At step 608, a portion of the component may be shot peened while at least one other portion of the component is shielded from media by the masking system. At step 610, once the media blasting process is complete, the first shell and second shell may be decoupled from each other and the intermediate member to disassociate the component from the masking system.

Thus as has been described, masking systems (e.g., masking system 100, masking system 100′, et cetera) disclosed herein may be used to selectively shield a portion of a component while another portion of a component is blasted with media. While the disclosure illustrates the masking systems (e.g., masking system 100, masking system 100′, et cetera) with reference to certain turbine components (such as blade 60), the masking systems disclosed herein may be used to selectively mask other components (e.g., other gas turbine components such as vanes, or other components that are to be blasted with media). Further, while the disclosure illustrates the masking systems with reference to a shot peening process, the masking systems disclosed herein may be used in association with other processes such as grit blasting, sand blasting, or other processes requiring selective masking of a component.

As used herein, the terms “first,” “second,” and “third” may be used interchangeably to distinguish one component from another and are not intended to signify location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The singular forms “a,” “an,” and “the” include plural references unless the context clearly dictates otherwise.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

The disclosure claimed is:

1. A masking system for selectively masking a component, the masking system comprising:
a first shell having a first seating area configured to seat at least a first part of a first side of the component;
a second shell having a second seating area configured to seat at least a second part of a second side of the component; and
an intermediate member securable to the first shell and the second shell such that when the first part and the second part are respectively seated within the first seating area and the second seating area, the intermediate member contacts a terminal portion of the component.

2. The masking system of claim 1, wherein:
the first shell has a first opening, the second shell has a second opening, and the intermediate member has a third opening;
the first opening, the second opening, and the third opening can be aligned; and
the alignment of the first opening, the second opening, and the third opening is associated with movement of the intermediate member towards the terminal portion of the component.

3. The masking system of claim 1, including a fastening system for securing the first shell, the second shell, and the intermediate member.

4. The masking system of claim 1, wherein the intermediate member has a first portion having a first angled end and a second angled end, a second portion that extends from the first angled end, and a third portion that extends from the second angled end.

5. The masking system of claim 4, wherein the second portion has a first projection and the third portion has a second projection that faces the first projection.

6. The masking system of claim 5, wherein at least one of the second projection and third projection is frusto-triangular.

7. The masking system of claim 6, wherein the intermediate member further comprises a plugging member for plugging an aperture in the component.

8. The masking system of claim 1, wherein at least a portion of each of the first shell and the second shell is compressible to allow the first shell and the second shell to be disposed in a can of a shot peen apparatus.

9. The masking system of claim 1, wherein the component is a gas turbine component.

10. The masking system of claim 9, wherein the gas turbine component is a blade.

11. The masking system of claim 10, wherein the first part includes at least a portion of a shank of the blade.

12. The masking system of claim 1, wherein the intermediate member is hollow.

13. The masking system of claim 12, wherein the intermediate member is filled with a strengthening material.

14. A masking system for selectively masking a component, the masking system comprising:
a first shell having a first portion and a second portion that extends from the first portion, the first portion having associated therewith a first seating area;
a second shell having a first part and a second part that extends from the first part, the first part having associated therewith a second seating area; and
an intermediate member securable to the first portion and the first part and configured to contact a terminal portion of the component when the component is retained within the first seating area and the second seating area.

15. The masking system of claim 14, wherein the intermediate member is generally U-shaped.

16. The masking system of claim 14, wherein each of the first shell and the second shell are additively manufactured.

17. A masking system for masking a component to undergo a media blasting process, the masking system comprising:
a first shell;
a second shell securable to the first shell; and
an intermediate member securable to the first shell and the second shell;
wherein, when the component is retained by the first shell and the second shell, a portion of the component extends from the first shell and the second shell and contacts the intermediate member.

18. The masking system of claim 17, wherein each of the first shell and the second shell have a compressible portion.

19. The masking system of claim 17, wherein:
the first shell has a first opening, the second shell has a second opening, and the intermediate member has a third opening;
the first opening, the second opening, and the third opening can be aligned; and
the alignment of the first opening, the second opening, and the third opening is associated with movement of the intermediate member towards the portion of the component.

20. The masking system of claim 17, further comprising a fastening system for fastening the first shell to each of the second shell and the intermediate member.
